(19) United States
(12) Patent Application Publication
(10) Pub. No.: US 2017/0342945 A1
(43) Pub. Date: Nov. 30, 2017

(54) Liquid Filter for Separating Water and/or Particle Filtration of a Fuel and/or Aqueous Solution, in Particular a Urea Solution, and/or Water

(71) Applicant: MANN+HUMMEL GMBH, Ludwigsburg (DE)

(72) Inventors: Sebastian Neubauer, Tornesch (DE); Lars Spelter, Ditzingen (DE); Jochen Krauss, Karlsruhe (DE)

(21) Appl. No.: 15/603,971

(22) Filed: May 24, 2017

(30) Foreign Application Priority Data
May 31, 2016 (DE) 102016006427.7

(51) Int. Cl. F02M 25/022; B01D 17/04; B01D 29/15; B01D 35/143

(52) U.S. Cl. CPC F02M 25/0224; B01D 35/143; B01D 17/045; B01D 29/15

(57) ABSTRACT

A liquid filter for water separation and/or particle filtration of a fuel and/or aqueous solution, in particular a urea solution, and/or water, in particular in a motor vehicle, is described. The liquid filter has at least one filter and/or coalescer medium that is made of a non-woven fabric that has fibers and/or threads having elementary silver.

### TECHNICAL FIELD

The present invention relates to a liquid filter according to the preamble of claim 1 and to a use of this liquid filter in a motor vehicle.

### BACKGROUND

A generic liquid filter is known from WO2015/018785 A1, for instance. Such liquid filters act, inter alia, as water separators for diesel fuels. In these and other fuels it is known that they include microorganisms that may accumulate and proliferate in the filter.

Known from DE 10 2008 034 903 A1 is providing the interior of a filter housing with a silver coating by means of a CVD coating process or alternatively reducing the biological activity of the separated water in the water collection chamber by using silver-coated plastic fibers. These measures reduce the biological activity in the water collection chamber, but the latter is downstream of the particle filter and coalescer element, which are thus not included in the antimicrobial treatment. However, when there are, e.g., lengthy standing times, microorganisms can continue to proliferate on the filter media themselves and thereby clog the pores of the filter medium.

### DISCLOSURE OF THE INVENTION

Proceeding from the present prior art, the object of the present invention is to reduce clogging of the pores of the filter media, especially the filter medium of the particle filter and/or of the coalescer filter element by the proliferation of microorganisms.

An inventive liquid filter may serve both for water separation and/or particle filtration of a fuel, or even for particle filtration of a urea solution that is used in newer diesel models for reducing nitrogen oxides.

A corresponding liquid filter may be particularly preferably employed in a motor vehicle. However, other applications in which internal combustion engines are used are also possible, such as, e.g. on boats.

According to the invention, the liquid filter comprises at least one filter and/or co alescer medium that is made of a non-woven fabric that comprises fibers and/or threads having elementary silver.

The filter medium may be a particle filter for reducing particulate impurities from the fuel or urea solution, for instance. Alternatively, the coalescer medium may also be provided in a coalescer element for enlarging water droplets in the fuel.

The non-woven fabric is made of the usual non-woven fabric fibers, but also comprises a certain portion of fibers and/or threads that comprise elementary silver or are coated with elementary silver. In one particularly preferred variant the non-woven fabric has fibers made of elementary silver.

Different from DE 10 2008 034 903 A1, in which the issue is keeping the water collection chamber clean, this invention relates to containing the growth of microorganisms directly on the filter and coalescer media. Thus, in the present invention, not only is the water in the collection chamber kept free of microorganisms, but growth directly on the filter media surfaces is also effectively inhibited, so that the service life of a liquid filter is significantly increased.

Additional advantageous variants of the invention are the subject matter of the subordinate claims.

The fibers and/or threads made of elementary silver may advantageously be embedded in the filter and/or coalescer medium.

The liquid filter may advantageously have a filter element that comprises the filter and/or coalescer medium and that is exchangeably arranged in a filter housing of the liquid filter. The coalescer medium is often also called the coalescence medium. In this way the filter and/or coalescer medium with the silver-containing fibers may be exchanged when clogged, e.g. by particulate impurities, and it is even possible for the soiled non-woven material, in particular the silver portion, to be subjected to a recovery process.

The filter housing may advantageously have a water collection chamber, for collecting water separated from the fuel, and a filter chamber, for cleaning the fuel, wherein the filter and/or coalescer medium is arranged in the filter chamber. Thus the filter housing is divided into a water collection chamber and a filter chamber. By arranging the silver fibers in the filter chamber, not only is the microbiological growth of micro-organisms in water disposed in the water collection chamber reduced, but the growth of the microorganisms directly on the filter medium is also reduced.

The filter and/or coalescer medium may advantageously be embodied as a pleated filter medium that has at least one layer of non-woven fabric and that is arranged in the filter housing in a star shape. Since the particle filter is generally the first filter the primary fuel flow strikes, the accumulation of microbiological organisms is the greatest there. Thus the silver has its greatest effect at this location.

The filter element may be arranged in the filter housing of the liquid filter such that at least one filter and/or coalescer medium is exposed to a primary flow of a fuel to be filtered when the liquid filter is used properly. This clarifies that the issue is not just cleaning the water in the water collection chamber. Instead, the issue is preventing microorganisms from clogging the pores of the filter medium. Since the different filter media are saturated with fuel, it is possible for microorganisms to grow directly on the filter medium, but this is to be prevented.

The fibers and/or threads may preferably be made of elementary silver.

For effective removal of particles or for effective coalescence of water drops, the non-woven fabric may comprise at least 50 wt. % non-woven fabric fibers that are made of polymer plastic fibers and/or glass fibers.

The preferred mean fiber diameter of the silver fibers may be between 300 nm and 20 μm, preferably between 800 nm and 15 μm. This achieves a surface that is favorable for the attachment and deactivation of microorganisms.

It may furthermore be provided that the filter and/or coalescer medium has at least one other biofunctional component, preferably a coating and/or a granulate that contain(s) silver. In one alternative embodiment, the coating and/or the granulate may also be used by themselves, i.e., without the aforesaid silver fibers or threads. Using a granulate whose grain size may be selected to be very small achieves a maximally active (outer) surface that clearly outperforms the active surface of the fibers/threads (cylinder shape).

The non-woven fabric of the liquid filter that has the silver-containing fibers may be used as a coalescer medium and/or particle filter medium for filtering a fuel and/or a urea solution in the context of the present invention.

The liquid filter may advantageously be arranged in the primary flow of a fuel line and/or a line for a urea solution in a motor vehicle, wherein this primary flow is conducted onto the filter and/or coalescer medium.

Furthermore, one advantageous use of the liquid filter is comprised in that it is arranged in a line of a water injection system of an internal combustion engine, in particular downstream of at least one water reservoir and upstream of at least one injection nozzle and/or injection valve of the water injection system. In addition, a plurality of such filters may be provided, for instance as pre-filter and primary filter, whose particle filter media have different structural sizes.

Systems for water injection are used in modern internal combustion engines, especially during full-load operation, to prevent otherwise normal enrichment of the mixture. In these operating circumstances, more fuel is supplied to the combustion chamber than would actually be required for stoichiometric combustion in order to attain cooling using additional fuel. In internal combustion engines with water injection, the task of cooling is assumed by the additionally injected water, wherein the water also has a significantly higher thermal capacity than fuel. Double-digit percentage reductions in consumption may be attained, with corresponding savings in CO₂. In addition, especially with turbo-charged engines, it is possible to attain an increase in performance, since the improved removal of heat decreases the tendency for knocking in the fuel-air mixture and thus higher charging pressures may be attained.

As is generally true with water or aqueous solutions, there is the risk, especially for long standing times and/or in the summer months, that a biofilm will form on a filter element associated with the water injection system, so-called biofouling. Otherwise, microorganisms and algae may deposit on the filter element if no active substances are added to the water (e.g. windshield wiper fluid or cooling water). In a filter suffering from biofouling, the differential pressure is very high and the filter does not function well any more; the invention prevents this, so that the operation of the vehicle is assured due to the lasting filtration action of the filter element for the water injection.

One primary area of application for the invention may therefore also be filters that clean water prior to injection into the intake system of a spark ignition engine.

### BRIEF DESCRIPTION OF THE DRAWINGS

The invention shall be explained in greater detail in the following using a specific exemplary embodiment and the figures. The figures are as follows.

FIG. 1 depicts a filter element having a plurality of filter and/or coalescer media for use in an inventive liquid filter for filtering a fuel in an internal combustion engine; and,

FIG. 2 depicts an inventive liquid filter having the filter element from FIG. 1.

### DETAILED DESCRIPTION

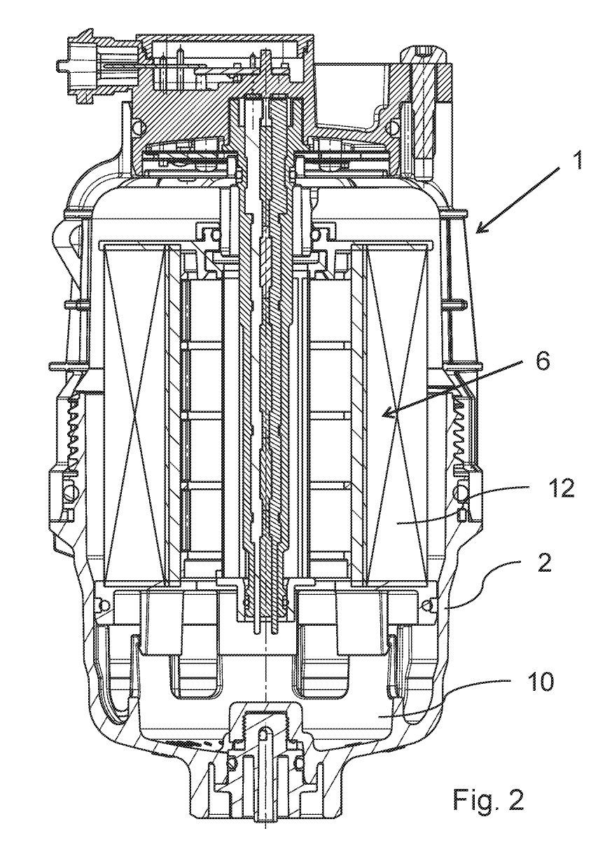

FIG. 2 is a longitudinal section of a liquid filter 1 for filtering fuel, preferably diesel fuel, and/or a urea solution. The liquid filter may preferably be used in an internal combustion engine. This liquid filter may be employed inter alia as a water separator or as a particle filter for separating particles from a liquid medium. The structure of the liquid filter itself is known in detail from WO2015/018785, referenced in its entire scope hereby with respect to the construction of a liquid filter in the context of the present invention.

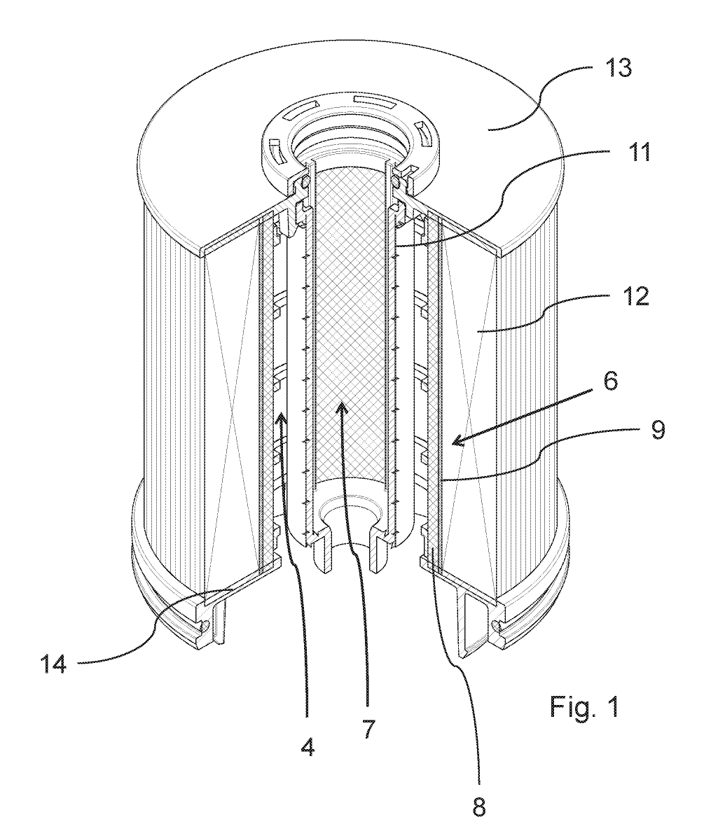

The liquid filter 1 comprises, inter alia, a filter housing 2 and filter element 6 arranged therein and depicted in detail in FIG. 1. The annular filter element 6 comprises a plurality of filter and/or coalescer media. A first filter medium is embodied as filter bellows 12 and the liquid to be filtered flows through it radially from outside to inside. Consequently the cylindrical interior in the filter element 6 forms a dean chamber 7 from which the cleaned liquid is axially removed. Inserted in the clean chamber 7 of the filter element 6 is a center or support tube 8 that preferably comprises plastic and that supports the filter medium or media of the filter element 6, imparting stability thereto. The center tube 8 lines the clean chamber 7.

On the radially interior side of the filter means of the filter element 6, the filter medium 6 has a coalescer element 9 with a coalescer medium. Finely distributed water droplets in the fuel agglomerate on the coalescer element 9 so that they become larger droplets. These water droplets, which are contained e.g. in the diesel fuel, bond to the coalescer medium of the coalescer element 9, creating larger drops; they coalesce. The volume may be further increased by downstream coalescer elements. The flow is guided such that large drops are separated from the fuel solely by means of gravity.

Disposed in the lower region, near the bottom, in the filter housing 2 is a water collection chamber 10 in which water is collected that is separated during the filtration of the liquid. The collected water may be removed via an opening on the bottom and a valve out of the water collection chamber 10 in the filter housing.

Inserted into the clean chamber 7 is a water separator screen 11 that is embodied as a hollow cylinder and that has an outer diameter that is smaller than the inner diameter of the center tube 8 so that an interposing annular chamber 4 is formed as part of the clean chamber 7. The water separator screen 11 may preferably have a water separating screen fabric as an additional filtration stage and as an additional barrier for any water droplets still present. The water separator screen 11 extends axially, like the center tube 8, across the entire length of the clean chamber 7 or filter element 6. The separated water droplets are removed via the lower axial end face of the clean chamber 7 into the water collection chamber 10.

The wall of the water separator screen 11 has a plurality of through-holes via which the cleaned fuel can flow radially inward into the interior of the water separator screen 11 out of the annular space between center tube 8 and water separator screen 11. Then the cleaned fuel, from which the water droplets have been removed, is removed axially via the axially upper end face of the clean chamber 7, which is in flow connection with the outlet line 5.

In FIG. 1 the filter element 6 is depicted in a perspective elevation, with a partial cut-away. The filter bellows 12 is enclosed on each end face by an end disk 13, 14.

It is functionally preferred that the liquid filter 1 has a three-stage structure. The pleated bellows 12 is primarily a particle filter and forms the first stage of the fuel cleaning. It removes particulate impurities from the fuel. The one or more coalescer elements 9 enlarge the water drops in the fuel in the second filtration stage. The water is separated using a hydrophobic barrier in the third stage. This third stage is formed by the water separator screen 11.

The water collection chamber 10 may be checked by a sensor and emptied when it is sufficiently full.

The filter elements with the filter and/or coalescer media, which form the first and second stages, may be subject to microbiological contamination and are preferably part of the aforesaid filter element 6. When too soiled, the latter may be exchanged.

In one preferred variant, the filter element 6 is provided as an exchangeable part in the liquid filter.

One or more of the aforesaid filter elements, that is, filter bellows 12 and/or coalescer element 9, are made of a single or multi-layer filter and/or coalescer medium that is made of a non-woven fabric and that has, in addition to the non-woven fabric fibers, silver fibers, that is, fibers that have elementary silver or comprise elementary silver. Continuous filaments may also be provided for the silver fibers. However, silver fibers having a mean fiber length of 5 μm to 3 cm are preferred. The mean fiber length may be determined statistically using microscopy.

Alternatively or in addition to the silver fibers, the nonwoven fabric may also have silver threads, that is, threads that comprise elementary silver or are coated with elementary silver.

The non-woven fabric of the filter medium is preferably a non-woven fabric that is chemically resistant to the fuel being used, especially diesel fuel.

The non-woven fabric may preferably comprise non-woven fabric fibers that are made of cellulose, polybutylene terephthalate, polyimide, and/or polypropylene, and/or glass fibers. The fibers are present in the non-woven fabric at greater than 50 wt. %, particularly preferred at greater than 80 wt. %.

As described in the foregoing, in addition to conventional non-woven fabric fibers, the non-woven fabric has fibers made of elementary silver or fibers that are coated with elementary silver. These silver fibers are distributed in the non-woven fabric and are present in the non-woven fabric at less than 50 wt. %, preferably at less than 20 wt. %.

Preferably the mean fiber diameter of the silver fibers may be between 300 nm and 20 μm, particularly preferably between 800 nm and 15 μm. The mean fiber diameter may be determined according to DIN 53811:1970-07.

The non-woven fabric may preferably be produced in the meltblown, spunbond, or wet-lay process. The silver fibers may preferably be worked into the filter and/or coalescer medium during production. The medium may comprise 100% silver fibers or also just a small portion thereof. A second fiber type may be full synthetic continuous fibers or even individual fibers with a finite length.

The filter medium may be constructed with a single layer and/or with multiple layers, wherein preferably at least one material layer is formed from the aforesaid silver fiber-containing non-woven fabric.

The filter element 6 is also preferably arranged in the primary flow of the fuel and/or urea solution.

The silver fibers worked into the non-woven fabric prevent or reduce at least the microbiological growth in the fuel or urea solution with which the filter medium is wetted following initial proper use. Thus a biofilm or bio-slime that can clog the filter medium is prevented from forming.

This tendency for microbiological growth is particularly pronounced during lengthy standing times, multiple recirculations of the fuel or urea solution, when there are frequent cold starts, and/or when short distances are driven.

The silver fibers and/or silver threads are preferably worked into the non-woven fabric. Thus silver threads, for instance, may be output onto a substrate through a second nozzle during a meltblown or spunbond process, while polymer fibers are applied through a first nozzle.

What is claimed is:

1. A liquid filter (1) for water separation and filtration of an aqueous solution, comprising:
at least one filter of a filter medium; and/or
a coalescer medium that is made of a nonwoven fabric, the nonwoven fabric comprising fibers and/or threads having elementary silver.

2. The liquid filter according to claim 1, wherein
the fibers and/or threads made of elementary silver are embedded into the filter medium and/or coalescer medium.

3. The liquid filter according to claim 1, wherein
the liquid filter has a filter element (6) that comprises the filter medium and/or coalescer medium;
wherein the liquid filter is exchangeably arranged into a filter housing (2) of the liquid filter (1).

4. The liquid filter according to claim 1, wherein
the filter housing (2) incoudes:
a water collection chamber (10) for collecting water separated from the fuel, and
a filter chamber (3), for cleaning the fuel;
wherein the filter and/or coalescer medium is arranged in the filter chamber.

5. The liquid filter according to claim 1, wherein
the filter and/or coalescer medium is embodied as a pleated filter medium that has
at least one layer of non-woven fabric and that is arranged in the filter housing (2) in a star shape.

6. The liquid filter according to claim 1, wherein
the filter element (6) is arranged in the filter housing (2) of the liquid filter (1) such that at least one filter and/or coalescer medium is exposed to a primary flow of a fuel to be filtered when the liquid filter (1).

7. The liquid filter according to claim 1, wherein
the fibers and/or threads are made of elementary silver.

8. The liquid filter according to claim 1, wherein
the non-woven fabric comprises at least 50 wt. % non-woven fabric fibers that are made of polymer plastic fibers and/or glass fibers.

9. The liquid filter according to claim 1, wherein
a mean fiber diameter of the silver fibers is between 300 nm and 20 μm.

10. The liquid filter according to claim 1, wherein
the filter and/or coalescer medium has at least one other biofunctional coating and/or a granulate that contain(s) silver.

11. The liquid filter according to claim 1, wherein
the coalescer medium and/or the filter medium is made of the non-woven material.

12. The liquid filter according to claim 1, wherein
the liquid filter (1) is arranged in a primary flow of a fuel line and/or a line for a urea solution, arranged in a motor vehicle; and
wherein the primary flow is conducted onto the filter and/or coalescer medium.

13. The liquid filter according to claim 12, wherein
the liquid filter (1) is arranged in a line of a water injection system of an internal combustion engine;
wherein the liquid filter (1) is arranged downstream of at least one water reservoir and upstream of at least one injection nozzle and/or injection valve of the water injection system.
